(19) United States
(12) Patent Application Publication
(10) Pub. No.: US 2026/0143319 A1
(43) Pub. Date: May 21, 2026

(54) SYSTEMS AND METHODS FOR SHARING CORE NETWORK APPLICATIONS BETWEEN NETWORKS

(71) Applicant: Verizon Patent and Licensing Inc., Basking Ridge, NJ (US)

(72) Inventors: Daniel L. WALKER, Wall Township, NJ (US); Kashif KHAN, Keller, TX (US); Shawn R. PUGH, Easton, PA (US); Steve L. PADILLA, Lewisville, TX (US)

(73) Assignee: Verizon Patent and Licensing Inc., Basking Ridge, NJ (US)

(21) Appl. No.: 18/906,318

(22) Filed: Oct. 4, 2024

(51) Int. Cl. H04W 4/50; H04L 65/1016; H04L 65/1104; H04W 8/22

(52) U.S. Cl. CPC H04W 4/50; H04L 65/1016; H04L 65/1104; H04W 8/22

(57) ABSTRACT

In some implementations, a first device associated with a first network may receive a service request associated with a user equipment (UE). The first device may transmit, based on a service provisioning profile associated with the UE, a signal to a second device associated with a second network, wherein the second device is capable of serving the service request, and wherein the service request is associated with sharing a core network application between the first network and the second network.

### BACKGROUND

Wireless communication systems are widely deployed to provide various telecommunication services such as telephony, video, data, messaging, and broadcasts. A wireless network may include one or more network nodes that support communication for wireless communication devices, such as a user equipment (UE).

### BRIEF DESCRIPTION OF THE DRAWINGS

FIG. 1 is a diagram of an example associated with a traditional voice over New Radio (VoNR) or voice over Long Term Evolution (VoLTE) Internet Protocol multimedia subsystem (IMS) flow.

FIG. 2 is a diagram of an example associated with a traditional non-shared application IMS flow.

FIG. 3 is a diagram of an example associated with a shared application IMS flow based on a direct invite.

FIG. 4 is a diagram of an example associated with a shared application IMS flow based on a direct application programming interface (API) query.

FIG. 5 is a diagram of an example associated with a shared application IMS flow based on a direct API query to a proxy telephony application server (TAS) (P-TAS).

FIG. 6 is a diagram of an example associated with a shared application IMS flow based on an invite to a P-TAS.

FIG. 7 is a diagram of exemplary code associated with a service provisioning profile.

FIG. 8 is a diagram of an example environment in which systems and/or methods described herein may be implemented.

FIG. 9 is a diagram of example components of one or more devices of FIG. 8.

FIG. 10 is a flowchart of an example process associated with sharing core network applications between networks.

### DETAILED DESCRIPTION OF EXAMPLE EMBODIMENTS

The following detailed description of example implementations refers to the accompanying drawings. The same reference numbers in different drawings may identify the same or similar elements.

A core network, or a backbone network, may be a central part of a telecommunications network that is responsible for routing traffic over an IMS network. The core network may be responsible for connecting networks, such as wide area networks (WANs) and/or local area networks (LANs). The core network may be responsible for routing traffic across networks and to devices, such as UEs. The traffic may include voice traffic and/or data traffic. The core network may be responsible for providing applications and/or services, which may be related to connectivity, mobility management, authentication, authorization, and/or subscriber data management.

In some cases, core network applications may be shared between different networks. Various application solutions may be supported that need to rely upon services housed within separate trusted networks. Telephony operators may introduce services which rely upon shared resources within each telephony operator network, where the shared resources may be leveraged in order to provide an intended service capability. As an example, one such service may include extension digit dialing. Extension digit dialing is a feature that allows users within a closed system to reach an internal phone line, or extension, by dialing a shorter set of digits instead of a full phone number. Extension digit dialing is typically only available for enterprise customers using a TAS specifically for enterprise customers. It may be useful for calling members of a group or within an enterprise. Extension digit dialing is typically a feature that is adjustable per user or enterprise entity within a sole telephony network operator, but now may be offered across different telephony network operators. However, offering such services across different telephony network operators often involves excessive signaling between numerous entities of the different networks. The excessive signaling may result in higher resource utilization, which may degrade an overall network performance.

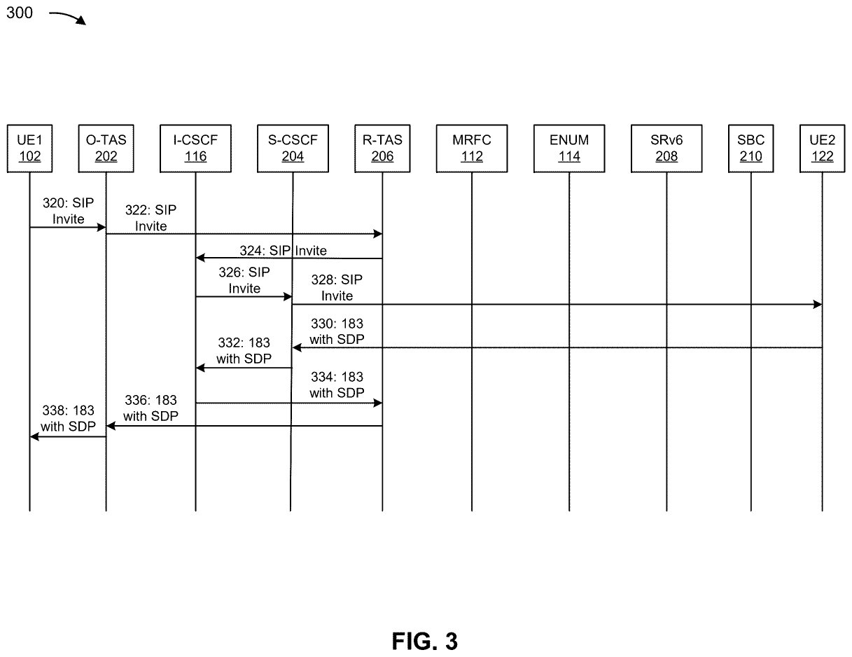

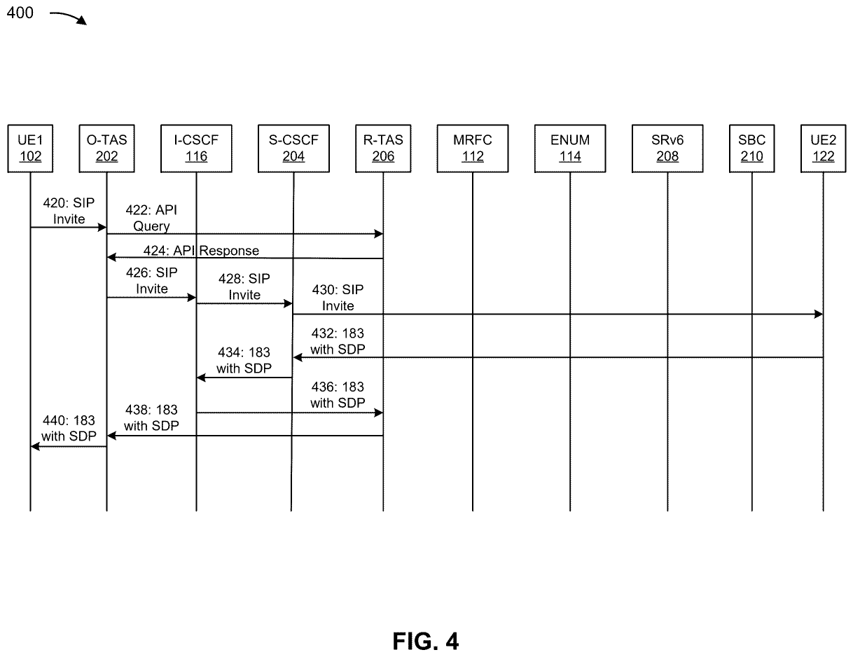

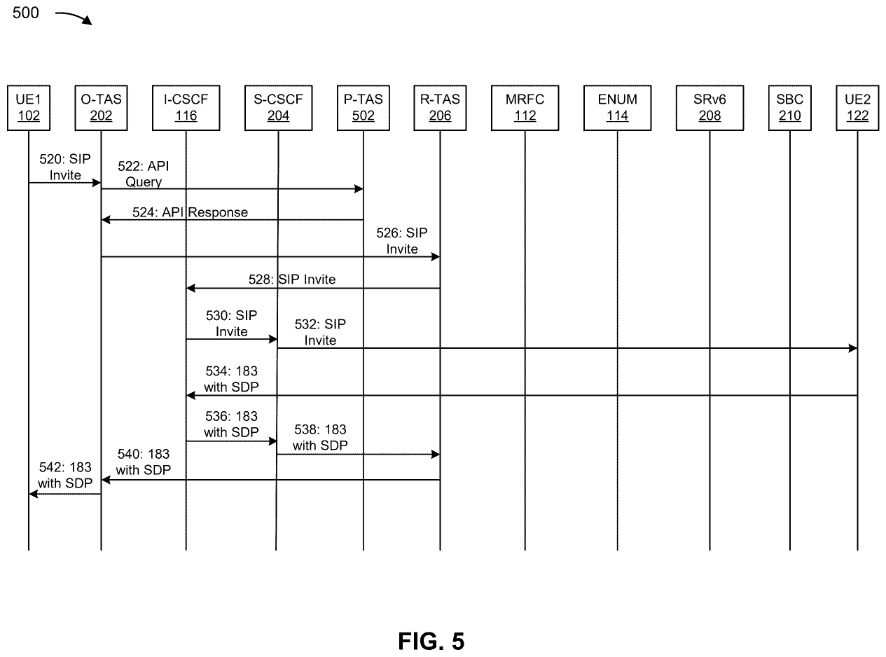

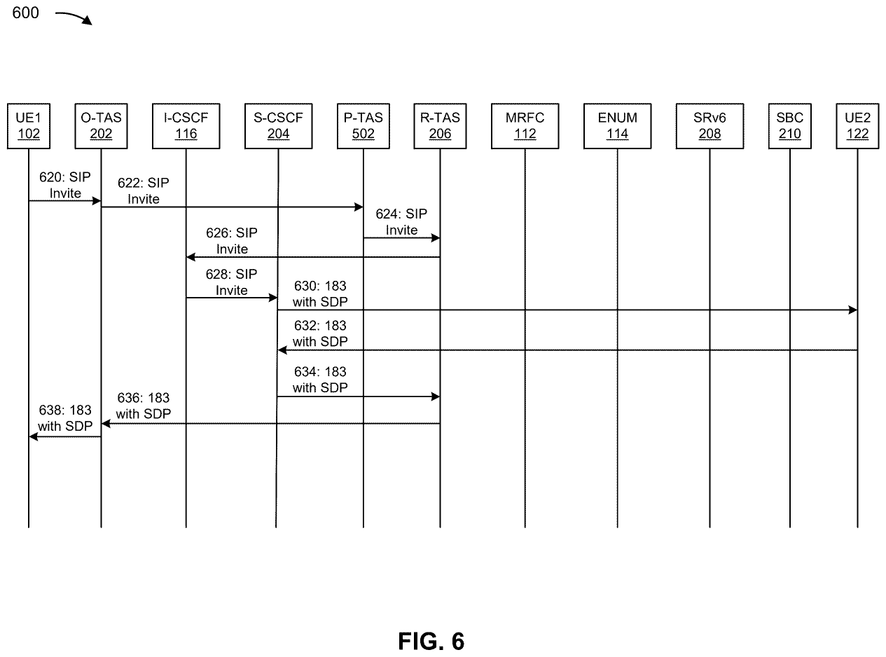

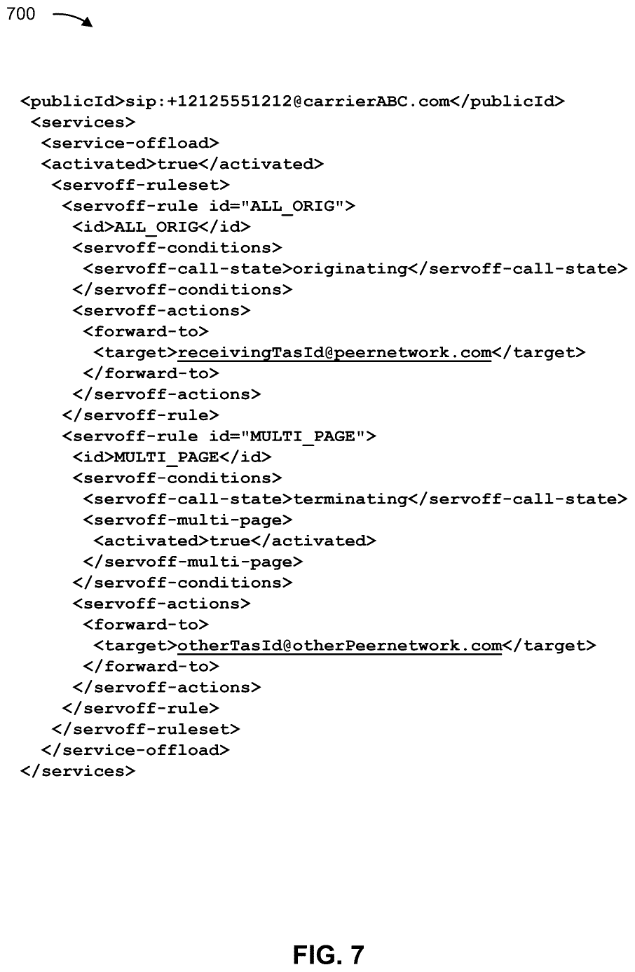

In some implementations, novel flows may be utilized for achieved shared application server services. In a first flow (e.g., as shown in FIG. 3), an originating TAS (O-TAS) associated with a first network may receive a service request. The service request may be from a first UE associated with the first network. The O-TAS may initiate a session initiation protocol (SIP) invite directly to a receiving TAS (R-TAS) associated with a second network. The O-TAS may initiate the SIP invite directly to the R-TAS based on a service provisioning profile that indicates the R-TAS. For example, the service provisioning profile may indicate a particular service associated with the service request is to be fulfilled by the R-TAS. One example of the service provisioning profile is shown in FIG. 7. The R-TAS may serve the service request, which may involve a second UE associated with the second network. In a second flow (e.g., as shown in FIG. 4), the O-TAS may receive the service request, and then the O-TAS may initiate an API query directly to the R-TAS, where the R-TAS may serve the service request. The O-TAS may not have an ability to complete the service request, whereas the R-TAS does have an ability to complete the service request. Rather than modifying the O-TAS to have an ability to serve the service request (e.g., offer the same feature as the R-TAS), the service request may be routed to the R-TAS for handling of the service request. As a result, TASs with duplicate services in separate networks may be minimized. The O-TAS may initiate the API query directly to the R-TAS based on the service provisioning profile that indicates the R-TAS. In a third flow (e.g., as shown in FIG. 5), the O-TAS may receive the service request, and then the O-TAS may initiate an API query to a P-TAS. The P-TAS may identify the R-TAS to be used for the service request, and the P-TAS may indicate the R-TAS to the O-TAS. For example, the P-TAS may respond to the O-TAS with a contact header of the R-TAS. The P-TAS may identify the R-TAS based on the service provisioning profile. The O-TAS may initiate a SIP invite to the R-TAS based on the indication received from the P-TAS, and then the R-TAS may serve the service request. In this example, the P-TAS may be a TAS that is shared by two networks, where the P-TAS may hold only a portion of a user profile for services being offloaded or shared. In a fourth flow (e.g., as shown in FIG. 6), the P-TAS may be used as an intermediate TAS for SIP signaling. In this example, the O-TAS may initiate a SIP invite to the P-TAS, where the P-TAS may forward the SIP invite to the R-TAS, and then the R-TAS may serve the service request. The P-TAS may identify the R-TAS based on the service provisioning profile.

In some implementations, by configuring the O-TAS to communicate directly with the R-TAS based on the service provisioning profile, or by configuring the O-TAS to communicate with the P-TAS which may then identify the R-TAS, the core network applications may be shared by the different networks using reduced signaling. Otherwise, additional signaling may be needed between various entities of the different networks, which would increase a signaling overhead. An ability to share the core network applications may allow a telephony network operator with a simplified path for sharing resources using peering protocol techniques between application servers (e.g., between TASs), instead of relying upon network-to-network development, which is typically derived of costly multiple vendor solutions. The telephony network operators may utilize the simplified path of communications between network applications, which may normally be utilized as part of a more complex or network challenging call flow. By leveraging an application-to-application supporting protocol, the same service may be provided with less resource utilization and less individual vendor feature development. Secure network protocols may be utilized along with an API language, which may reduce the need to develop feature specific services or costly functionalities per vendor for needed services within the telephony operator network, thereby improving an overall system performance.

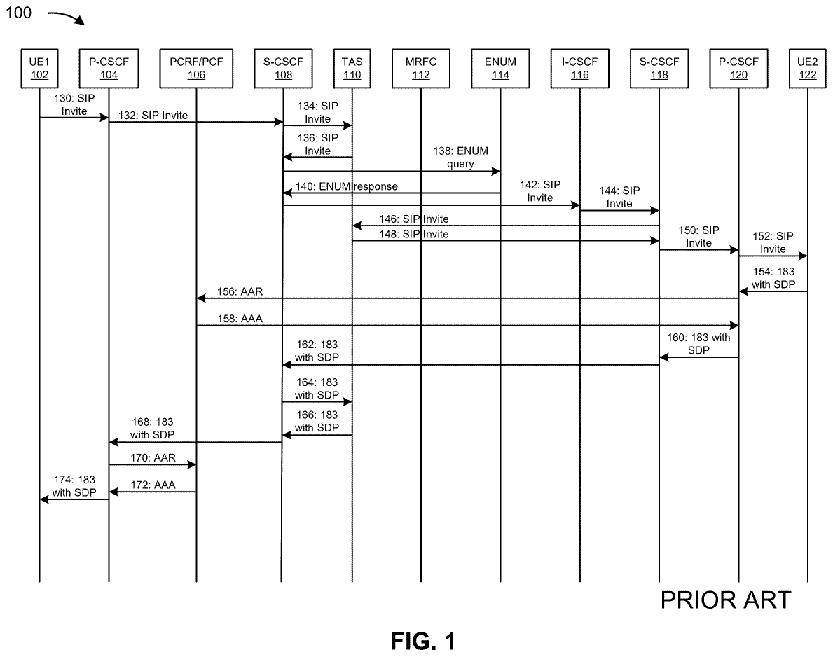

FIG. 1 is a diagram of an example 100 associated with a traditional VoNR or VoLTE IMS flow. As shown in FIG. 1, example 100 includes a first UE (UE1) 102, a first proxy call session control function (CSCF) (P-CSCF) 104, a policy and charging rules function (PCRF) or policy control function (PCF) (PCRF/PCF) 106, a first serving CSCF (S-CSCF) 108, a TAS 110, a multimedia resource function controller (MRFC) 112, an enumeration (ENUM) entity 114, an interrogating CSCF (I-CSCF) 116, a second S-CSCF 118, a second P-CSCF 120, and a second UE (UE2) 122.

As shown by reference number 130, in the traditional VoNR or VoLTE IMS flow, the first UE 102 may transmit, to the first P-CSCF 104, a SIP invite that contains a session description protocol (SDP). As shown by reference number 132, the first P-CSCF 104 may transmit the SIP invite to the first S-CSCF 108. As shown by reference number 134, the first S-CSCF 108 may transmit the SIP invite to the TAS 110. As shown by reference number 136, the TAS 110 may transmit the SIP invite to the first S-CSCF 108. The TAS 110 may execute originating services for the first UE 102 and translate dialed digits if needed. As shown by reference number 138, the first S-CSCF 108 may transmit an ENUM query to the ENUM entity 114. As shown by reference number 140, the ENUM entity 114 may transmit an ENUM response to the S-CSCF 108. The ENUM entity 114 may respond with an IMS domain. An IMS routing may be dependent on translated digits from the TAS 110 or the ENUM response.

As shown by reference number 142, the first S-CSCF 108 may transmit the SIP invite to the I-CSCF 116. As shown by reference number 144, the I-CSCF 116 may transmit the SIP invite to the second S-CSCF 118. As shown by reference number 146, the second S-CSCF 118 may transmit the SIP invite to the TAS 110. As shown by reference number 148, the TAS 110 may transmit the SIP invite to the second S-CSCF 118. As shown by reference number 150, the second S-CSCF 118 may transmit the SIP invite to the second P-CSCF 120. As shown by reference number 152, the second P-CSCF 120 may transmit the SIP invite to the second UE 122.

As shown by reference number 154, the second UE 122 may transmit, to the second P-CSCF 120, a 183 session progress response (SIP response) that contains an SDP. Alternatively, the second UE 122 may transmit, to the second P-CSCF 120, a 180 response without an SDP. As shown by reference number 156, the second P-CSCF 120 may transmit an authorization authentication request (AAR) to the PCRF/PCF 106. As shown by reference number 158, the PCRF/PCF 106 may transmit an authorization authentication answer (AAA) to the second P-CSCF 120. As shown by reference number 160, the second P-CSCF 120 may transmit the 183 session progress response to the second S-CSCF 118. As shown by reference number 162, the second S-CSCF 118 may transmit the 183 session progress response to the first S-CSCF 108. As shown by reference number 164, the first S-CSCF 108 may transmit the 183 session progress response to the TAS 110. As shown by reference number 166, the TAS 110 may transmit the 183 session progress response to the first S-CSCF 108. As shown by reference number 168, the first S-CSCF 108 may transmit the 183 session progress response to the first P-CSCF 104. As shown by reference number 170, the first P-CSCF 104 may transmit an AAR to the PCRF/PCF 106. As shown by reference number 172, the PCRF/PCF 106 may transmit an AAA to the first P-CSCF 104. As shown by reference number 174, the first P-CSCF 104 may transmit the 183 session progress response to the first UE 102.

A real-time transport protocol (RTP) media path may be created between the first UE 102 and the second UE 122. Provisional acknowledgements (PRACKs), acknowledgments (ACKs) to invite 200 OK messages, BYE messages, and/or 200 OK to BYE messages may follow a same resource path as the SIP invite and the 183 session progress response. The traditional VoNR or VoLTE IMS flow may be associated with a relatively large number of steps, which may result in increased resource utilization and increased signaling overhead.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

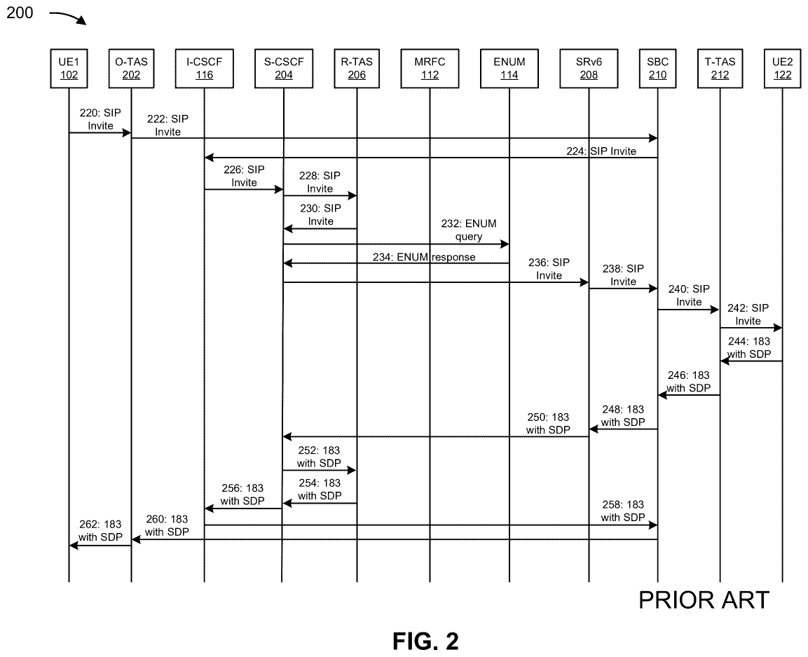

FIG. 2 is a diagram of an example 200 associated with a traditional non-shared application IMS flow. As shown in FIG. 2, example 200 includes a first UE (UE1) 102, an O-TAS 202, an I-CSCF 116, an S-CSCF 204, an R-TAS 206, an MRFC 112, an ENUM entity 114, a segment routing over an Internet Protocol version 6 data plane (SRv6) entity 208, a session border controller (SBC) 210, a terminating TAS (T-TAS) 212, and a second UE (UE2) 122.

As shown by reference number 220, in the traditional non-shared application IMS flow, the first UE 102 may transmit, to the O-TAS 202, a SIP invite that contains an SDP. The first UE 102 may transmit the SIP invite to the O-TAS 202 via a P-CSCF and/or an S-CSCF (e.g., as shown in FIG. 1). As shown by reference number 222, the O-TAS 202 may transmit the SIP invite to the SBC 210. As shown by reference number 224, the SBC 210 may transmit the SIP invite to the I-CSCF 116. As shown by reference number 226, the I-CSCF 116 may transmit the SIP invite to the S-CSCF 204. As shown by reference number 228, the S-CSCF 204 may transmit the SIP invite to the R-TAS 206. As shown by reference number 230, the R-TAS 206 may transmit the SIP invite to the S-CSCF 204. The R-TAS 206 may execute originating services for the first UE 102 and translate dialed digits if needed.

As shown by reference number 232, the S-CSCF 204 may transmit an ENUM query to the ENUM entity 114. As shown by reference number 234, the ENUM entity 114 may transmit an ENUM response to the S-CSCF 204. The ENUM response may return an operator connect mobile (OCM) partner domain, which may trigger a route to the SRv6 entity 208. As shown by reference number 236, the S-CSCF 204 may transmit the SIP invite to the SRv6 entity 208. As shown by reference number 238, the SRv6 entity 208 may transmit the SIP invite to the SBC 210. As shown by reference number 240, the SBC 210 may transmit the SIP invite to the T-TAS 212. As shown by reference number 242, the T-TAS 212 may transmit the SIP invite to the second UE 122.

As shown by reference number 244, the second UE 122 may transmit, to the T-TAS 212, a 183 session progress response that contains an SDP. Alternatively, the second UE 122 may transmit, to the T-TAS 212, a 180 response without an SDP. As shown by reference number 246, the T-TAS 212 may transmit the 183 session progress response to the SBC 210. As shown by reference number 248, the SBC 210 may transmit the 183 session progress response to the SRv6 entity 208. As shown by reference number 250, the SRv6 entity 208 may transmit the 183 session progress response to the S-CSCF 204. As shown by reference number 252, the S-CSCF 204 may transmit the 183 session progress response to the R-TAS 206. As shown by reference number 254, the R-TAS 206 may transmit the 183 session progress response to the S-CSCF 204. As shown by reference number 256, the S-CSCF 204 may transmit the 183 session progress response to the I-CSCF 116. As shown by reference number 258, the I-CSCF 116 may transmit the 183 session progress response to the SBC 210. As shown by reference number 260, the SBC 210 may transmit the 183 session progress response to the O-TAS 202. As shown by reference number 262, the O-TAS 202 may transmit the 183 session progress response to the first UE 102.

An RTP media path may be created between the first UE 102 and the second UE 122. PRACKs, ACKs to invite 200 OK messages, BYE messages, and/or 200 OK to BYE messages may follow a same resource path as the SIP invite and the 183 session progress response. The traditional non-shared application IMS flow may be associated with a relatively large number of steps, which may result in increased resource utilization and increased signaling overhead.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

FIG. 3 is a diagram of an example 300 associated with a shared application IMS flow based on a direct invite. As shown in FIG. 3, example 300 includes a first UE (UE1) 102, an O-TAS 202, an I-CSCF 116, an S-CSCF 204, an R-TAS 206, an MRFC 112, an ENUM entity 114, an SRv6 entity 208, an SBC 210, and a second UE (UE2) 122.

In some implementations, the O-TAS 202, which may be associated with a first network, may receive a service request. The service request may be from the first UE 102, which may be associated with the first network. The O-TAS 202 may initiate a SIP invite directly to the R-TAS 206, which may be associated with a second network. The O-TAS 202 may initiate the SIP invite directly to the R-TAS 206 based on a service provisioning profile (e.g., as shown in FIG. 7) that indicates the R-TAS 206. For example, the service provisioning profile may indicate a particular service associated with the service request is to be fulfilled by the R-TAS 206.

As shown by reference number 320, in the shared application IMS flow based on the direct invite, the first UE 102 may transmit, to the O-TAS 202, the SIP invite that contains an SDP. The first UE 102 may transmit the SIP invite to the O-TAS 202 via a P-CSCF and/or an S-CSCF (e.g., as shown in FIG. 1). The O-TAS 202 may execute originating services for the first UE 102, and based on a provisioning (e.g., the service provisioning profile), the O-TAS 202 may have information on a fully qualified domain name (FQDN) of the R-TAS 206. The O-TAS 202 may attempt to route to the R-TAS 206 based on a service request. As shown by reference number 322, the O-TAS 202 may transmit the SIP invite to the R-TAS 206. The R-TAS 206 may execute a requested service for the first UE 102 (e.g., an extension dialing for the first UE 102 to terminate to the second UE 122). The SIP invite may be associated with a route header R-TAS FQDN. As shown by reference number 324, the R-TAS 206 may transmit the SIP invite to the I-CSCF 116. As shown by reference number 326, the I-CSCF 116 may transmit the SIP invite to the S-CSCF 204. As shown by reference number 328, the S-CSCF 204 may transmit the SIP invite to the second UE 122.

As shown by reference number 330, the second UE 122 may transmit, to the S-CSCF 204, a 183 session progress response that contains an SDP. Alternatively, the second UE 122 may transmit, to the S-CSCF 204, a 180 response without an SDP. As shown by reference number 332, the S-CSCF 204 may transmit the 183 session progress response to the I-CSCF 116. As shown by reference number 334, the I-CSCF 116 may transmit the 183 session progress response to the R-TAS 206. As shown by reference number 336, the R-TAS 206 may transmit the 183 session progress response to the O-TAS 202. As shown by reference number 338, the O-TAS 202 may transmit the 183 session progress response to the first UE 102.

An RTP media path may be created between the first UE 102 and the second UE 122. PRACKs, ACKs to invite 200 OK messages, BYE messages, and/or 200 OK to BYE messages may follow a same resource path as the SIP invite and the 183 session progress response.

As indicated above, FIG. 3 is provided as an example. Other examples may differ from what is described with regard to FIG. 3. The number and arrangement of devices shown in FIG. 3 are provided as an example. In practice, there may be additional devices, fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) shown in FIG. 3 may perform one or more functions described as being performed by another set of devices shown in FIG. 3.

FIG. 4 is a diagram of an example 400 associated with a shared application IMS flow based on a direct API query. As shown in FIG. 4, example 400 includes a first UE (UE1) 102, an O-TAS 202, an I-CSCF 116, an S-CSCF 204, an R-TAS 206, an MRFC 112, an ENUM entity 114, an SRv6 entity 208, an SBC 210, and a second UE (UE2) 122.

In some implementations, the O-TAS 202 may receive a service request. The O-TAS 202 may initiate an API query directly to the R-TAS 206, where the R-TAS 206 may serve the service request. The O-TAS 202 may initiate the API query directly to the R-TAS 206 based on a service provisioning profile (e.g., as shown in FIG. 7) that indicates the R-TAS 206.

As shown by reference number 420, in the shared application IMS flow based on the direct API query, the first UE 102 may transmit, to the O-TAS 202, a SIP invite that contains an SDP. The first UE 102 may transmit the SIP invite to the O-TAS 202 via a P-CSCF and/or an S-CSCF (e.g., as shown in FIG. 1). The O-TAS 202 may initiate the API query directly to a defined service TAS to serve a request for the first UE 102. As shown by reference number 422, the O-TAS 202 may transmit the API query to the R-TAS 206. The R-TAS 206 may execute the defined service requested by the O-TAS 202 to serve the request for the first UE 102, and the R-TAS 206 may relay back an action to the O-TAS 202. As shown by reference number 424, the R-TAS 206 may transmit an API response to the O-TAS 202. As shown by reference number 426, the O-TAS 202 may transmit the SIP invite to the I-CSCF 116. As shown by reference number 428, the I-CSCF 116 may transmit the SIP invite to the S-CSCF 204. As shown by reference number 430, the S-CSCF 204 may transmit the SIP invite to the second UE 122

As shown by reference number 432, the second UE 122 may transmit, to the S-CSCF 204, a 183 session progress response that contains an SDP. Alternatively, the second UE 122 may transmit, to the S-CSCF 204, a 180 response without an SDP. As shown by reference number 434, the S-CSCF 204 may transmit the 183 session progress response to the I-CSCF 116. As shown by reference number 436, the I-CSCF 116 may transmit the 183 session progress response to the R-TAS 206. As shown by reference number 438, the R-TAS 206 may transmit the 183 session progress response to the O-TAS 202. As shown by reference number 440, the O-TAS 202 may transmit the 183 session progress response to the first UE 102.

An RTP media path may be created between the first UE 102 and the second UE 122. PRACKs, ACKs to invite 200 OK messages, BYE messages, and/or 200 OK to BYE messages may follow a same resource path as the SIP invite and the 183 session progress response.

As indicated above, FIG. 4 is provided as an example. Other examples may differ from what is described with regard to FIG. 4. The number and arrangement of devices shown in FIG. 4 are provided as an example. In practice, there may be additional devices, fewer devices, different devices, or differently arranged devices than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) shown in FIG. 4 may perform one or more functions described as being performed by another set of devices shown in FIG. 4.

FIG. 5 is a diagram of an example 500 associated with a shared application IMS flow based on a direct API query to a P-TAS. As shown in FIG. 5, example 500 includes a first UE (UE1) 102, an O-TAS 202, an I-CSCF 116, an S-CSCF 204, a P-TAS 502, an R-TAS 206, an MRFC 112, an ENUM entity 114, an SRv6 entity 208, an SBC 210, and a second UE (UE2) 122.

In some implementations, the O-TAS 202 may receive a service request. The O-TAS 202 may initiate an API query to a P-TAS 502. The P-TAS 502 may identify the R-TAS 206 to be used for the service request. The P-TAS 502 may indicate the R-TAS 206 to the O-TAS 202. For example, the P-TAS 502 may respond to the O-TAS 202 with a contact header of the R-TAS 206. The P-TAS 502 may identify the R-TAS 206 based on a service provisioning profile (e.g., as shown in FIG. 7). The O-TAS 202 may initiate the SIP invite to the R-TAS 206 based on the indication received from the P-TAS 502, and then the R-TAS 206 may serve the service request. In this example, the P-TAS 502 may be a TAS that is shared by two networks, where the P-TAS 502 may hold only a portion of a user profile (e.g., the service provisioning profile) for services being offloaded or shared.

As shown by reference number 520, in the shared application IMS flow based on the direct API query to the P-TAS 502, the first UE 102 may transmit, to the O-TAS 202, the SIP invite that contains an SDP. The first UE 102 may transmit the SIP invite to the O-TAS 202 via a P-CSCF and/or an S-CSCF (e.g., as shown in FIG. 1). The O-TAS 202 may initiate an API query to the P-TAS 502 to identify the R-TAS 206 that is able to serve a request for the first UE 102. As shown by reference number 522, the O-TAS 202 may transmit the API query to the P-TAS 502. The P-TAS 502 may identify (e.g., from the service provisioning profile) a TAS FQDN to be used for the service requested by the O-TAS 202 to serve the request for the first UE 102, and the P-TAS 502 may relay back an action to the O-TAS 202. As shown by reference number 524, the P-TAS 502 may transmit an API response to the O-TAS 202. As shown by reference number 526, the O-TAS 202 may transmit the SIP invite to the R-TAS 206. The R-TAS 206 may execute the service requested by the O-TAS 202 to serve the request for the first UE 102.

As shown by reference number 528, the R-TAS 206 may transmit the SIP invite to the I-CSCF 116. As shown by reference number 530, the I-CSCF 116 may transmit the SIP invite to the S-CSCF 204. As shown by reference number 532, the S-CSCF 204 may transmit the SIP invite to the second UE 122.

As shown by reference number 534, the second UE 122 may transmit, to the I-CSCF 116, a 183 session progress response that contains an SDP. Alternatively, the second UE 122 may transmit, to the I-CSCF 116, a 180 response without an SDP. As shown by reference number 536, the I-CSCF 116 may transmit the 183 session progress response to the S-CSCF 204. As shown by reference number 538, the S-CSCF 204 may transmit the 183 session progress response to the R-TAS 206. As shown by reference number 540, the R-TAS 206 may transmit the 183 session progress response to the O-TAS 202. As shown by reference number 542, the O-TAS 202 may transmit the 183 session progress response to the first UE 102.

An RTP media path may be created between the first UE 102 and the second UE 122. PRACKs, ACKs to invite 200 OK messages, BYE messages, and/or 200 OK to BYE messages may follow a same resource path as the SIP invite and the 183 session progress response.

As indicated above, FIG. 5 is provided as an example. Other examples may differ from what is described with regard to FIG. 5. The number and arrangement of devices shown in FIG. 5 are provided as an example. In practice, there may be additional devices, fewer devices, different devices, or differently arranged devices than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) shown in FIG. 5 may perform one or more functions described as being performed by another set of devices shown in FIG. 5.

FIG. 6 is a diagram of an example 600 associated with a shared application IMS flow based on an invite to a P-TAS. As shown in FIG. 6, example 600 includes a first UE (UE1) 102, an O-TAS 202, an I-CSCF 116, an S-CSCF 204, a P-TAS 502, an R-TAS 206, an MRFC 112, an ENUM entity 114, an SRv6 entity 208, an SBC 210, and a second UE (UE2) 122.

In some implementations, the P-TAS 502 may be used as an intermediate TAS for SIP signaling. The O-TAS 202 may initiate a SIP invite to the P-TAS 502, where the P-TAS 502 may forward the SIP invite to the R-TAS 206, and then the R-TAS 206 may serve a service request. The P-TAS 502 may identify the R-TAS 206 based on a service provisioning profile (e.g., as shown in FIG. 7).

As shown by reference number 620, in the shared application IMS flow based on the invite to the P-TAS 502, the first UE 102 may transmit, to the O-TAS 202, the SIP invite that contains an SDP. The first UE 102 may transmit the SIP invite to the O-TAS 202 via a P-CSCF and/or an S-CSCF (e.g., as shown in FIG. 1). The O-TAS 202 may initiate an API query to the P-TAS 502 to identify the R-TAS 206 that is able to serve a request for the first UE 102. As shown by reference number 622, the O-TAS 202 may transmit the SIP invite to the P-TAS 502. The P-TAS 502 may identify (e.g., from the service provisioning profile) a TAS FQDN to be used for the service requested by the O-TAS 202 to serve the request for the first UE 102, and the P-TAS 502 may relay the SIP invite to the R-TAS 206. As shown by reference number 624, the P-TAS 502 may transmit the SIP invite to the R-TAS 206. As shown by reference number 626, the R-TAS 206 may transmit the SIP invite to the I-CSCF 116. The R-TAS 206 may execute the service requested by the O-TAS 202 to serve the request for the first UE 102, and the R-TAS 206 may relay the SIP invite to the second UE 122. As shown by reference number 628, the I-CSCF 116 may transmit the SIP invite to the S-CSCF 204.

As shown by reference number 630, the S-CSCF 204 may transmit, to the second UE 122, a 183 session progress response that contains an SDP. Alternatively, the S-CSCF 204 may transmit, to the second UE 122, a 180 response without an SDP. As shown by reference number 632, the second UE 122 may transmit the 183 session progress response to the S-CSCF 204. As shown by reference number 634, the S-CSCF 204 may transmit the 183 session progress response to the R-TAS 206. As shown by reference number 636, the R-TAS 206 may transmit the 183 session progress response to the O-TAS 202. As shown by reference number 638, the O-TAS 202 may transmit the 183 session progress response to the first UE 102.

An RTP media path may be created between the first UE 102 and the second UE 122. PRACKs, ACKs to invite 200 OK messages, BYE messages, and/or 200 OK to BYE messages may follow a same resource path as the SIP invite and the 183 session progress response.

As indicated above, FIG. 6 is provided as an example. Other examples may differ from what is described with regard to FIG. 6. The number and arrangement of devices shown in FIG. 6 are provided as an example. In practice, there may be additional devices, fewer devices, different devices, or differently arranged devices than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) shown in FIG. 6 may perform one or more functions described as being performed by another set of devices shown in FIG. 6.

FIG. 7 is a diagram of exemplary code 700 associated with a service provisioning profile.

As shown in FIG. 7, the service provisioning profile may define different services that are to be fulfilled by different TASs. For example, for each service, the service provisioning profile may indicate an identifier of a corresponding TAS. The service provisioning profile may be used to determine which element (e.g., which TAS) is to serve a

particular type of service request. As an example, originating calls made by a UE may be forwarded to a peer network R-TAS (e.g., an R-TAS ID associated with a peer network). When activated, terminating calls may be forwarded to a separate server that handles call forking services for the UE. The separate server may be associated with another TAS ID, where the other TAS ID may be associated with another peer network.

As indicated above, FIG. 7 is provided as an example. Other examples may differ from what is described with regard to FIG. 7.

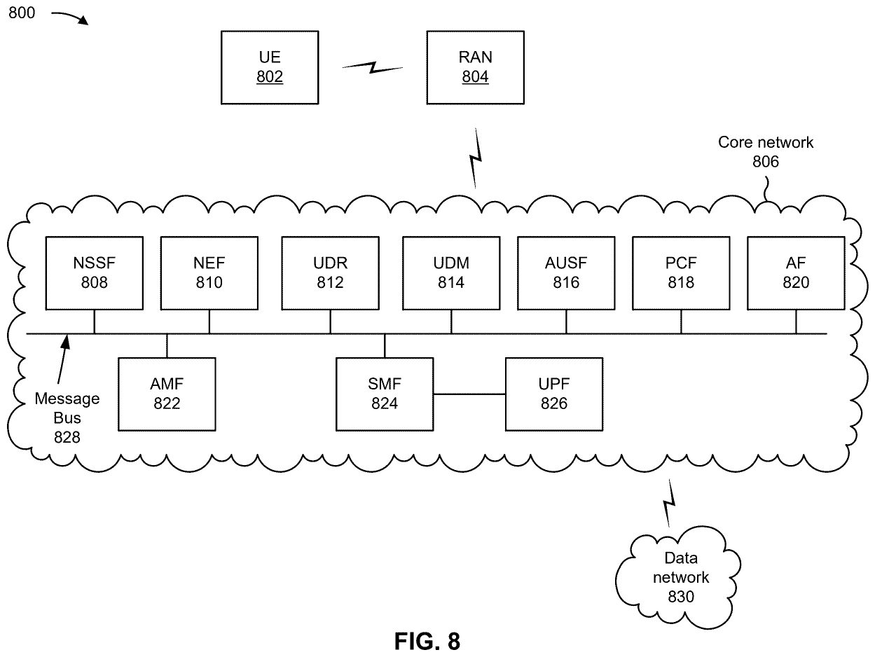

FIG. 8 is a diagram of an example environment 800 in which systems and/or methods described herein may be implemented. As shown in FIG. 8, example environment 800 may include a UE 802, a radio access network (RAN) 804, a core network 806, and a data network 830. Devices and/or networks of example environment 800 may interconnect via wired connections, wireless connections, or a combination of wired and wireless connections.

The UE 802 may include one or more devices capable of receiving, generating, storing, processing, and/or providing information, such as information described herein. For example, the UE 802 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The RAN 804 may support, for example, a cellular radio access technology (RAT). The RAN 804 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 802. A base station may be a disaggregated base station. The disaggregated base station may be configured to utilize a protocol stack that is physically or logically distributed among two or more nodes, which may include a radio unit (RU), a distributed unit (DU), and a centralized unit (CU). The RAN 804 may transfer traffic between the UE 802 (e.g., using a cellular RAT), one or more base stations (e.g., using a wireless interface or a backhaul interface, such as a wired backhaul interface), and/or the core network 806. The RAN 804 may provide one or more cells that cover geographic areas.

In some implementations, the RAN 804 may perform scheduling and/or resource management for the UE 802 covered by the RAN 804 (e.g., the UE 802 covered by a cell provided by the RAN 804). In some implementations, the RAN 804 may be controlled or coordinated by a network controller, which may perform load balancing, network-level configuration, and/or other operations. The network controller may communicate with the RAN 804 via a wireless or wireline backhaul. In some implementations, the RAN 804 may include a network controller, a self-organizing network (SON) module or component, or a similar module or component. In other words, the RAN 804 may perform network control, scheduling, and/or network management functions (e.g., for uplink, downlink, and/or sidelink communications of the UE 802 covered by the RAN 804).

In some implementations, the core network 806 may include an example functional architecture in which systems and/or methods described herein may be implemented. For example, the core network 806 may include an example architecture of a 5G next generation (NG) core network included in a 5G wireless telecommunications system. While the example architecture of the core network 806 shown in FIG. 8 may be an example of a service-based architecture, in some implementations, the core network 806 may be implemented as a reference-point architecture and/or a 4G core network, among other examples.

As shown in FIG. 8, the core network 806 may include a number of functional elements. The functional elements may include, for example, a network slice selection function (NSSF) 808, a network exposure function (NEF) 810, a unified data repository (UDR) 812, a unified data management (UDM) 814, an authentication server function (AUSF) 816, a PCF 818, an application function (AF) 820, an access and mobility management function (AMF) 822, a session management function (SMF) 824, and/or a user plane function (UPF) 826. These functional elements may be communicatively connected via a message bus 828. Each of the functional elements shown in FIG. 8 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 808 may include one or more devices that select network slice instances for the UE 802. The NSSF 808 may allow an operator to deploy multiple substantially independent end-to-end networks potentially with the same infrastructure. In some implementations, each slice may be customized for different services. The NEF 810 may include one or more devices that support exposure of capabilities and/or events in the wireless telecommunications system to help other entities in the wireless telecommunications system discover network services.

The UDR 812 may include one or more devices that provide a converged repository, which may be used by network functions to store data. For example, a converged repository of subscriber information may be used to service a number of network functions. The UDM 814 may include one or more devices to store user data and profiles in the wireless telecommunications system. The UDM 814 may generate authentication vectors, perform user identification handling, perform subscription management, and perform other various functions. The AUSF 816 may include one or more devices that act as an authentication server and support the process of authenticating the UE 802 in the wireless telecommunications system.

The PCF 818 may include one or more devices that provide a policy framework that incorporates network slicing, roaming, packet processing, and/or mobility management, among other examples. The AF 820 may include one or more devices that support application influence on traffic routing, access to the NEF 810, and/or policy control, among other examples. The AMF 822 may include one or more devices that act as a termination point for non-access stratum (NAS) signaling and/or mobility management, among other examples. The SMF 824 may include one or more devices that support the establishment, modification, and release of communication sessions in the wireless telecommunications system. For example, the SMF 824 may configure traffic steering policies at the UPF 826 and/or may enforce UE internet protocol (IP) address allocation and policies, among other examples. The UPF 826 may include one or more devices that serve as an anchor point for intra-RAT and/or inter-RAT mobility. The UPF 826 may apply rules to packets, such as rules pertaining to packet routing, traffic reporting, and/or handling user plane QoS, among other examples. The message bus 828 may represent a communication structure for communication among the functional elements. In other words, the message bus 828 may permit communication between two or more functional elements.

The data network 830 may include one or more wired and/or wireless data networks. For example, the data network 830 may include an IMS, a public land mobile network (PLMN), a LAN, a WAN, a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 8 are provided as an example. In practice, there may be additional devices and/or networks, fewer devices and/or networks, different devices and/or networks, or differently arranged devices and/or networks than those shown in FIG. 8. Furthermore, two or more devices shown in FIG. 8 may be implemented within a single device, or a single device shown in FIG. 8 may be implemented as multiple, distributed devices. Additionally, or alternatively, a set of devices (e.g., one or more devices) of example environment 800 may perform one or more functions described as being performed by another set of devices of example environment 800.

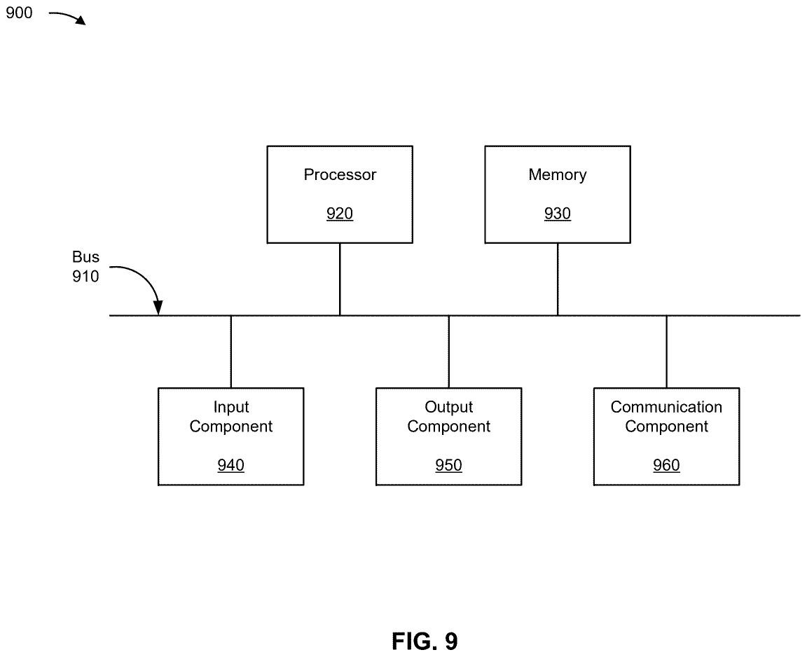

FIG. 9 is a diagram of example components of a device 900 associated with sharing core network applications between networks. The device 900 may correspond to an O-TAS (e.g., O-TAS 202). In some implementations, the O-TAS may include one or more devices 900 and/or one or more components of the device 900. As shown in FIG. 9, the device 900 may include a bus 910, a processor 920, a memory 930, an input component 940, an output component 950, and/or a communication component 960.

The bus 910 may include one or more components that enable wired and/or wireless communication among the components of the device 900. The bus 910 may couple together two or more components of FIG. 9, such as via operative coupling, communicative coupling, electronic coupling, and/or electric coupling. For example, the bus 910 may include an electrical connection (e.g., a wire, a trace, and/or a lead) and/or a wireless bus. The processor 920 may include a central processing unit, a graphics processing unit, a microprocessor, a controller, a microcontroller, a digital signal processor, a field-programmable gate array, an application-specific integrated circuit, and/or another type of processing component. The processor 920 may be implemented in hardware, firmware, or a combination of hardware and software. In some implementations, the processor 920 may include one or more processors capable of being programmed to perform one or more operations or processes described elsewhere herein.

The memory 930 may include volatile and/or nonvolatile memory. For example, the memory 930 may include random access memory (RAM), read only memory (ROM), a hard disk drive, and/or another type of memory (e.g., a flash memory, a magnetic memory, and/or an optical memory). The memory 930 may include internal memory (e.g., RAM, ROM, or a hard disk drive) and/or removable memory (e.g., removable via a universal serial bus connection). The memory 930 may be a non-transitory computer-readable medium. The memory 930 may store information, one or more instructions, and/or software (e.g., one or more software applications) related to the operation of the device 900. In some implementations, the memory 930 may include one or more memories that are coupled (e.g., communicatively coupled) to one or more processors (e.g., processor 920), such as via the bus 910. Communicative coupling between a processor 920 and a memory 930 may enable the processor 920 to read and/or process information stored in the memory 930 and/or to store information in the memory 930.

The input component 940 may enable the device 900 to receive input, such as user input and/or sensed input. For example, the input component 940 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 950 may enable the device 900 to provide output, such as via a display, a speaker, and/or a light-emitting diode. The communication component 960 may enable the device 900 to communicate with other devices via a wired connection and/or a wireless connection. For example, the communication component 960 may include a receiver, a transmitter, a transceiver, a modem, a network interface card, and/or an antenna.

The device 900 may perform one or more operations or processes described herein. For example, a non-transitory computer-readable medium (e.g., memory 930) may store a set of instructions (e.g., one or more instructions or code) for execution by the processor 920. The processor 920 may execute the set of instructions to perform one or more operations or processes described herein. In some implementations, execution of the set of instructions, by one or more processors 920, causes the one or more processors 920 and/or the device 900 to perform one or more operations or processes described herein. In some implementations, hardwired circuitry may be used instead of or in combination with the instructions to perform one or more operations or processes described herein. Additionally, or alternatively, the processor 920 may be configured to perform one or more operations or processes described herein. Thus, implementations described herein are not limited to any specific combination of hardware circuitry and software.

The number and arrangement of components shown in FIG. 9 are provided as an example. The device 900 may include additional components, fewer components, different components, or differently arranged components than those shown in FIG. 9. Additionally, or alternatively, a set of components (e.g., one or more components) of the device 900 may perform one or more functions described as being performed by another set of components of the device 900.

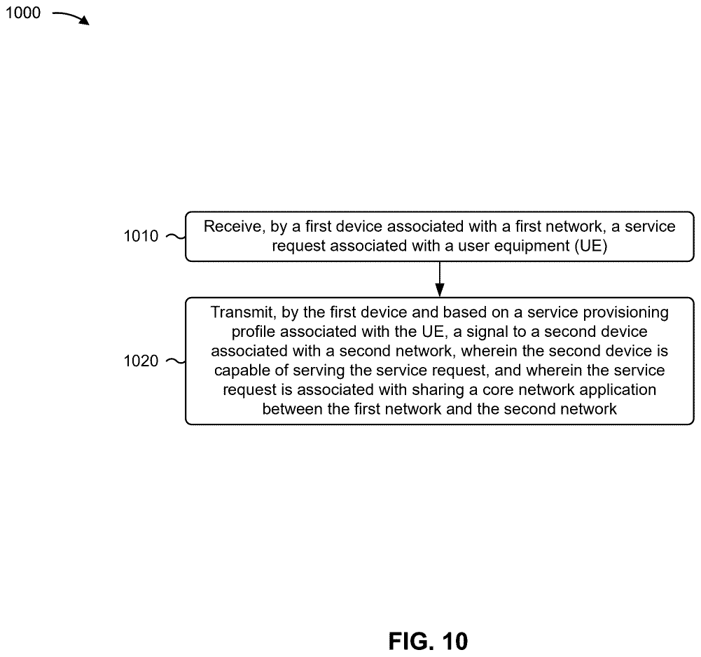

FIG. 10 is a flowchart of an example process 1000 associated with sharing core network applications between networks. In some implementations, one or more process blocks of FIG. 10 may be performed by an O-TAS (e.g., O-TAS 202). In some implementations, one or more process blocks of FIG. 10 may be performed by another entity or a group of entities separate from or including the O-TAS. Additionally, or alternatively, one or more process blocks of FIG. 10 may be performed by one or more components of device 900, such as processor 920, memory 930, input component 940, output component 950, and/or communication component 960.

As shown in FIG. 10, process 1000 may include receiving, by a first device associated with a first network, a service request associated with a UE (block 1010). The first device may be an O-TAS or a first peering application server. As an example, the service request may be associated with an extension digit dialing.

As shown in FIG. 10, process 1000 may include transmitting, by the first device and based on a service provisioning profile (e.g., as shown in FIG. 7) associated with the UE, a signal to a second device associated with a second network (block 1020). The second device may be capable of serving the service request. The second device may be an R-TAS or a second peering application server. The service request may be associated with sharing a core network application between the first network and the second network. The service provisioning profile may indicate one or more identifiers associated with one or more second devices in one or more respective second networks. Different second devices may be associated with different services. An identifier of the second device may be identified from the service provisioning profile based on the service request.

In some implementations, the first device, when transmitting the signal, may transmit a SIP invite message to the second device. In some implementations, the first device, when transmitting the signal, may transmit an API query to the second device. An API response may be received based on the API query. In some implementations, the first device may transmit, to a third device, an API query. The first device may receive, from the third device, an API response that indicates the second device. The signal may be transmitted to the second device based on the API response. The signal may be associated with the SIP invite message. In some implementations, the first device, when transmitting the signal, may transmit the signal to the second device via a third device, where the signal may be associated with the SIP invite message. In some aspects, the core network application may be shared between the first network and the second network using the third device. The third device may be a P-TAS. The core network application may be an IMS application.

Although FIG. 10 shows example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a first device associated with a first network, a service request associated with a user equipment (UE); and
transmitting, by the first device and based on a service provisioning profile associated with the UE, a signal to a second device associated with a second network, wherein the second device is capable of serving the service request, and wherein the service request is associated with sharing a core network application between the first network and the second network.

2. The method of claim 1, wherein the service provisioning profile indicates one or more identifiers associated with one or more second devices in one or more respective second networks, wherein different second devices are associated with different services, and wherein an identifier of the second device is identified from the service provisioning profile based on the service request.

3. The method of claim 1, wherein the first device is an originating telephony application server and the second device is a receiving telephony application server.

4. The method of claim 1, wherein the first device is a first peering application server and the second device is a second peering application server.

5. The method of claim 1, wherein transmitting the signal comprises:
transmitting a session initiation protocol (SIP) invite message to the second device.

6. The method of claim 1, wherein transmitting the signal comprises:
transmitting an application programming interface (API) query to the second device, wherein an API response is received based on the API query.

7. The method of claim 1, further comprising:
transmitting, to a third device, an application programming interface (API) query; and
receiving, from the third device, an API response that indicates the second device, wherein the signal is transmitted to the second device based on the API response, and wherein the signal is associated with a session initiation protocol (SIP) invite message.

8. The method of claim 1, wherein transmitting the signal comprises:
transmitting the signal to the second device via a third device, wherein the signal is associated with a session initiation protocol (SIP) invite message.

9. The method of claim 1, wherein the core network application is shared between the first network and the second network using a third device, and wherein the third device is a proxy telephony application server.

10. The method of claim 1, wherein the core network application is an Internet Protocol multimedia subsystem (IMS) application.

11. A first device associated with a first network, the first device comprising:
one or more processors configured to:
receive a service request associated with a user equipment (UE); and
transmit, based on a service provisioning profile associated with the UE, a signal to a second device associated with a second network, wherein the second device is capable of serving the service request, and wherein the service request is associated with sharing a core network application between the first network and the second network.

12. The first device of claim 11, wherein the service provisioning profile indicates one or more identifiers associated with one or more second devices in one or more respective second networks, wherein different second devices are associated with different services, and wherein an identifier of the second device is identified from the service provisioning profile based on the service request.

13. The first device of claim 11, wherein the first device is an originating telephony application server and the second device is a receiving telephony application server.

14. The first device of claim 11, wherein the first device is a first peering application server and the second device is a second peering application server.

15. The first device of claim 11, wherein the one or more processors, to transmit the signal, are configured to:
transmit a session initiation protocol (SIP) invite message to the second device.

16. The first device of claim 11, wherein the one or more processors, to transmit the signal, are configured to:
transmit an application programming interface (API) query to the second device, wherein an API response is received based on the API query.

17. The first device of claim 11, wherein the one or more processors are further configured to:
transmit, to a third device, an application programming interface (API) query; and
receive, from the third device, an API response that indicates the second device, wherein the signal is transmitted to the second device based on the API response, and wherein the signal is associated with a session initiation protocol (SIP) invite message.

18. The first device of claim 11, wherein the one or more processors, to transmit the signal, are configured to:
transmit the signal to the second device via a third device, wherein the signal is associated with a session initiation protocol (SIP) invite message.

19. The first device of claim 11, wherein the core network application is shared between the first network and the second network using a third device, wherein the third device is a proxy telephony application server, and wherein the core network application is an Internet Protocol multimedia subsystem (IMS) application.

20. A non-transitory computer-readable medium storing a set of instructions, the set of instructions comprising:
one or more instructions that, when executed by one or more processors of a first device associated with a first network, cause the first device to:
receive a service request associated with a user equipment (UE); and
transmit, based on a service provisioning profile associated with the UE, a signal to a second device associated with a second network, wherein the second device is capable of serving the service request, and wherein the service request is associated with sharing a core network application between the first network and the second network.
